(19) United States
(12) Patent Application Publication
(10) Pub. No.: US 2010/0033875 A1
(43) Pub. Date: Feb. 11, 2010

(54) Suspension board with circuit

(75) Inventors: Yoshinari Yoshida, Osaka (JP); Hitoki Kanagawa, Osaka (JP)

Correspondence Address: AKERMAN SENTERFITT, 8100 BOONE BOULEVARD, SUITE 700, VIENNA, VA, 22182-2683, US

(73) Assignee: Nitto Denko Corporation, Osaka (JP)

(21) Appl. No.: 12/458,993

(22) Filed: Jul. 29, 2009

Related U.S. Application Data
(60) Provisional application No. 61/136,029, filed on Aug. 7, 2008.

(30) Foreign Application Priority Data
Aug. 6, 2008 (JP) 2008-202665

(51) Int. Cl. G11B 5/48

(52) U.S. Cl. 360/244.1; G9B/5.147

(57) ABSTRACT

A suspension board with circuit includes a metal supporting board extending in a longitudinal direction, an insulating layer formed on the metal supporting board, and a conductive pattern formed on the insulating layer. In the suspension board with circuit, a magnetic-head mounting region where a slider with a magnetic head mounted thereon is mounted is located in one end portion in the longitudinal direction, and the thickness of the metal supporting board in at least a part of the magnetic-head mounting region is smaller than that in a region other than the magnetic-head mounting region.

### CROSS-REFERENCE TO RELATED APPLICATIONS

This application claims the benefit of U.S. Provisional Application No. 61/136,029, filed Aug. 7, 2008, and claims priority from Japanese Patent Application No. 2008-202665, filed Aug. 6, 2008, the contents of which are herein incorporated by reference in their entirety.

### BACKGROUND OF THE INVENTION

1. Field of the Invention

The present invention relates to a suspension board with circuit and, more particularly, to a suspension board with circuit used appropriately in a hard disk drive.

2. Description of the Related Art

Conventionally, a suspension board with circuit for mounting thereon a magnetic head has been used in a hard disk drive. For example, a suspension board with circuit has been proposed in which an insulating layer and a conductive layer are successively laminated on a stainless steel foil base material (see, e.g., Japanese Unexamined Patent Publication No. 10-12983).

In the suspension board with circuit proposed in Japanese Unexamined Patent Publication No. 10-12983, the stainless steel foil base material supports a slider with a magnetic head mounted thereon to hold a minute gap between the magnetic head and a magnetic disk, while causing the magnetic head and the magnetic disk to travel relatively to each other.

In recent years, for an improved recording density of a hard disk drive, there has been a demand to further reduce the gap between a magnetic head and a magnetic disk. To satisfy the demand, it is necessary to cause the magnetic head to flexibly follow even minute depressions and projections on the surface of the magnetic disk, and accurately hold the gap between the magnetic head and the magnetic disk.

### SUMMARY OF THE INVENTION

In the suspension board with circuit proposed in Japanese Unexamined Patent Publication No. 10-12983, the followability of the magnetic head with respect to the magnetic disk can be improved if the thickness of the stainless steel foil base material is reduced. However, when the thickness of the stainless steel foil base material is entirely reduced, the rigidity of the stainless steel foil base material decreases. As a result, in a process of producing the suspension board with circuit, deformation such as a warp or a crinkle is likely to occur to result in the problem of production of a defective product.

In addition, when the suspension board with circuit having the thin stainless steel foil base material is incorporated into the hard disk drive, the problem of a degraded handling property also occurs due to the decreased rigidity.

It is therefore an object of the present invention to provide a suspension board with circuit having an excellent handling property in which deformation can be prevented, while the followability of a magnetic head is improved.

A suspension board with circuit of the present invention includes a metal supporting board extending in a longitudinal direction, an insulating layer formed on the metal supporting board, and a conductive pattern formed on the insulating layer, wherein a magnetic-head mounting region where a slider with a magnetic head mounted thereon is mounted is located in one end portion in the longitudinal direction, and a thickness of the metal supporting board in at least a part of the magnetic-head mounting region is smaller than that in a region other than the magnetic-head mounting region.

In the suspension board with circuit of the present invention, it is preferable that an opening having a generally U-shaped shape which is open toward one side in the longitudinal direction is formed in the magnetic-head mounting region, and the magnetic-head mounting region includes a tongue portion interposed in the opening in a perpendicular direction perpendicular to the longitudinal direction, and an outrigger portion located on both outsides in the perpendicular direction of the opening, wherein the thickness of the metal supporting board in at least the tongue portion and/or the outrigger portion is smaller than that in the region other than the magnetic-head mounting region.

In the suspension board with circuit of the present invention, it is preferable that the thickness of the metal supporting board in at least the part of the magnetic-head mounting region is not less than 10 μm and is less than 15 μm, and the thickness of the metal supporting board in the region other than the magnetic-head mounting region is not less than 15 μm and not more than 25 μm.

In the suspension board with circuit of the present invention, it is preferable that the thickness of the metal supporting board in at least the part of the magnetic-head mounting region is smaller by 1 to 15 μm than that in the region other than the magnetic-head mounting region.

In the suspension board with circuit of the present invention, the metal supporting board in at least the part of the magnetic-head mounting region is formed thinner than that in the region other than the magnetic-head mounting region. This can allow the metal supporting board in the magnetic-head mounting region to have excellent flexibility and followability. When the slider is mounted on the magnetic-head mounting region, the magnetic head can be allowed to flexibly follow depressions and projections on the surface of a magnetic disk. Therefore, it is possible to improve the recording density of a hard disk drive.

On the other hand, the metal supporting board in the region other than the magnetic-head mounting region is formed thicker than that in at least the part of the magnetic-head mounting region. This can ensure high rigidity to the metal supporting board in the region other than the magnetic-head mounting region.

As a result, when the suspension board with circuit is mounted in the hard disk drive, it is possible to provide the magnetic head with excellent followability with respect to the magnetic disk, while preventing the production of a defective product during the production of the suspension board with circuit. In addition, when the suspension board with circuit is incorporated into the hard disk drive, it can be incorporated with an excellent handling property.

### BRIEF DESCRIPTION OF THE DRAWINGS

FIG. 1 is a partially cut-away plan view of an embodiment of a suspension board with circuit of the present invention;

FIG. 2 is a cross-sectional view along the line A-A of the front end portion of the suspension board with circuit shown in FIG. 1;

FIG. 3 is a process view for illustrating a producing method of the suspension board with circuit,

(a) showing the step of preparing a metal supporting board,

(b) showing the step of forming an insulating base layer on the metal supporting board,

(c) showing the step of forming a conductive pattern on the insulating base layer, and

(d) showing the step of forming an insulating cover layer on the insulating base layer;

FIG. 4 is a process view for illustrating the producing method of the suspension board with circuit, subsequently to FIG. 3,

(e) showing the step of forming a metal plating layer on the surface of each terminal portion,

(f) showing the step of etching a lower portion of the metal supporting board in a gimbal portion, and

(g) showing the step of trimming the metal supporting board, while forming a slit;

FIG. 5 is a process view for illustrating the etching step,

(a) showing the step of laminating an etching resist on each of the top surface and back surface of the suspension board with circuit, and

(b) showing the step of removing the lower portion of the metal supporting board exposed from the etching resist by etching; and

FIG. 6 is an enlarged plan view of a principal portion of another embodiment of the suspension board with circuit of the present invention.

### DETAILED DESCRIPTION OF THE INVENTION

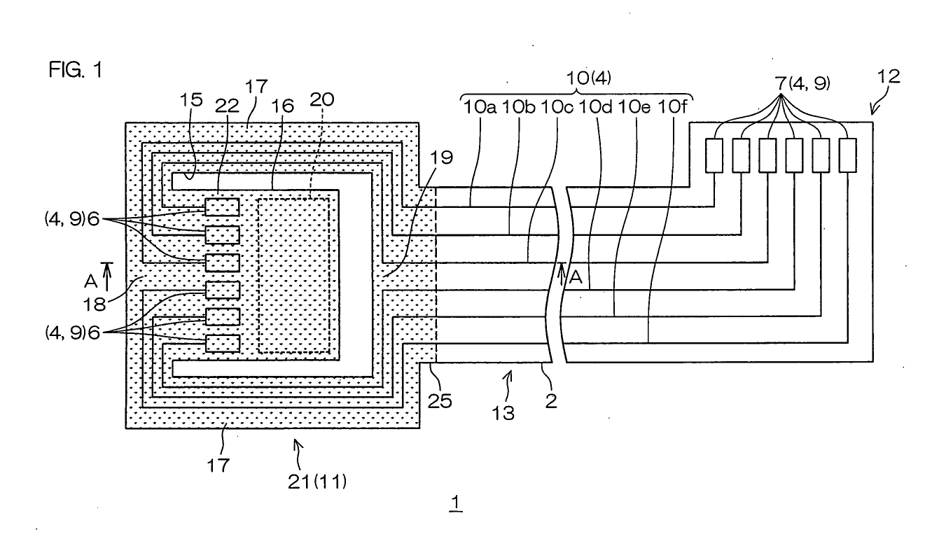

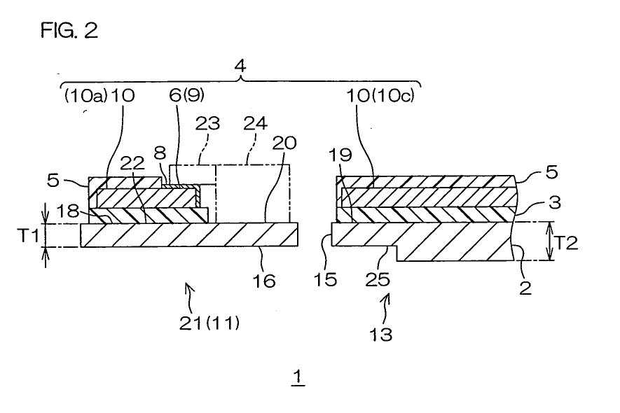

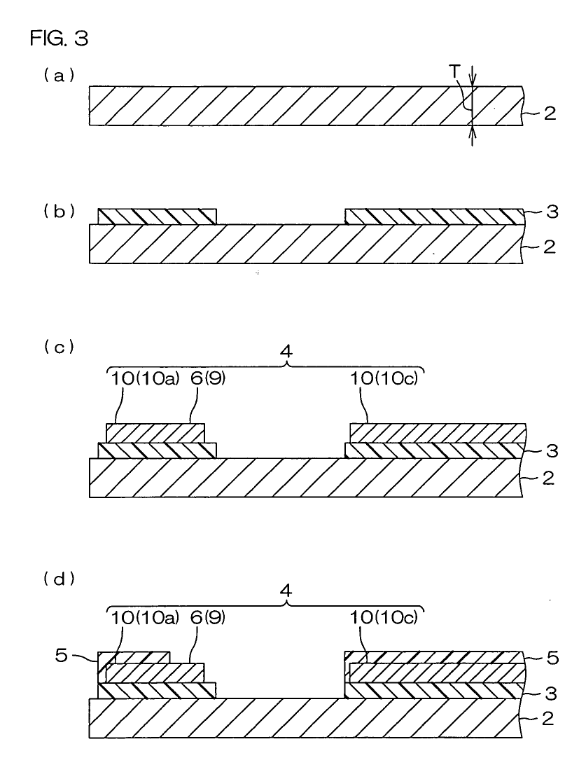

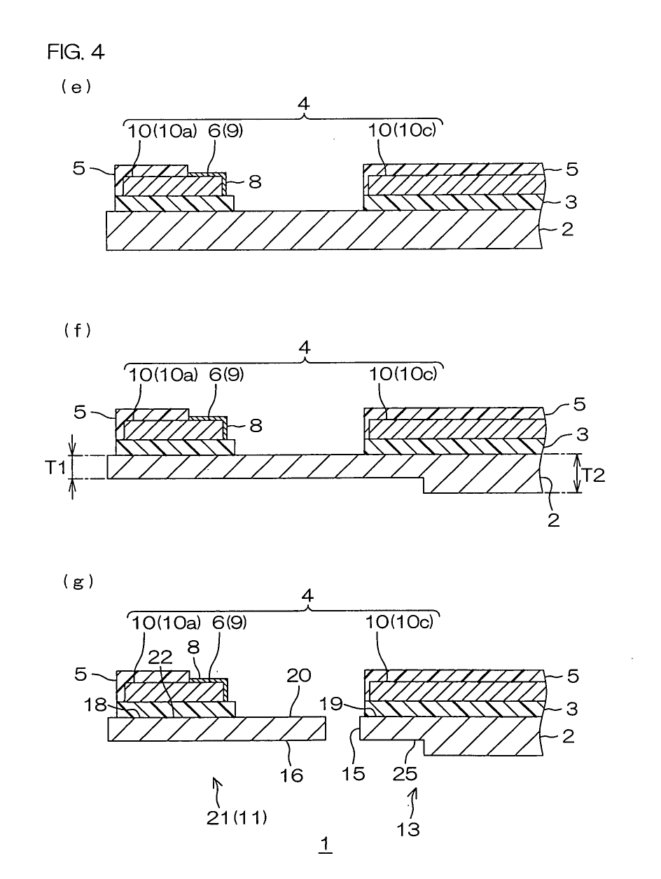

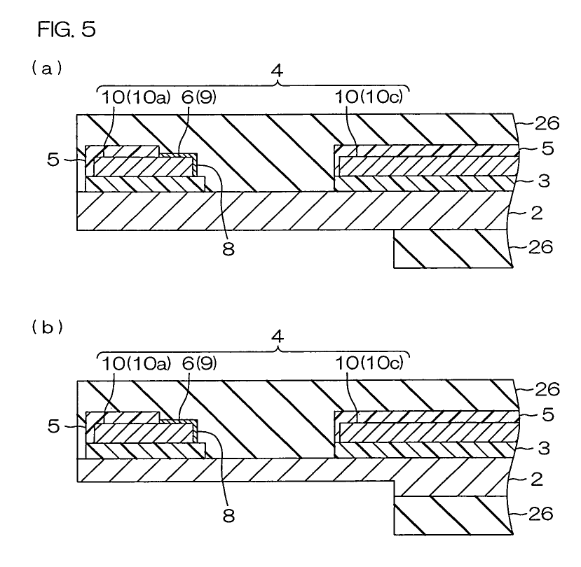

FIG. 1 is a partially cut-away plan view of an embodiment of a suspension board with circuit of the present invention. FIG. 2 is a cross-sectional view along the line A-A of one longitudinal end portion (front end portion) of the suspension board with circuit shown in FIG. 1. FIGS. 3 and 4 are process views each for illustrating a producing method of the suspension board with circuit. FIG. 5 is a process view for illustrating the etching step. In FIG. 1, an insulating base layer 3, an insulating cover layer 5, and a metal plating layer 8, each described later, are omitted for clear illustration of relative positioning of a conductive pattern 4 with respective to a metal supporting board 2 described later.

In FIG. 1, in the suspension board with circuit 1, the conductive pattern 4 for connecting a magnetic head 23 (the imaginary line of FIG. 2) of a hard disk drive and an external board (not shown) such as a read/write board is integrally formed on the metal supporting board on which a slider 24 (the imaginary line of FIG. 2) with the magnetic head 23 mounted thereon is mounted.

The metal supporting board 2 is provided in order to hold a minute gap between the magnetic head 23 mounted thereon and a magnetic disk (not shown), while causing the magnetic head 23 to travel relatively to the magnetic disk. The metal supporting board 2 is formed correspondingly to the outer shape of the suspension board with circuit 1, and formed in a generally flat-belt plan view shape extending in a longitudinal direction.

The conductive pattern 4 integrally includes head-side terminal portions 6 to be connected to connection terminals (not shown) of the magnetic head 23, external terminal portions 7 to be connected to connection terminals (not shown) of the external board, and a plurality of wires 10 for connecting the head-side terminal portions 6 and the external terminal portions 7 (which may be hereinafter generally and simply referred to as “terminal portions 9”), each described later.

The head-side terminal portions 6 are disposed at the front end portion of the suspension board with circuit 1. The front end portion of the suspension board with circuit 1 serves as a magnetic-head mounting region 11.

The external terminal portions 7 are disposed at the other end portion (hereinafter referred to as a rear end portion) in the longitudinal direction of the suspension board with circuit 1. The rear end portion of the suspension board with circuit 1 serves as an external region 12. In the suspension board with circuit 1, the portion located between the magnetic-head mounting region 11 (corresponding to a gimbal portion 21 described later) and the external region 12 serves as a wiring portion 13. The external region 12 is formed in a generally rectangular plan view shape projecting from one end in a widthwise direction (direction perpendicular to the longitudinal direction) of the rear end portion of the wiring portion 13 toward one widthwise side.

The wiring portion 13 is formed in a generally rectangular plan view shape extending in the longitudinal direction. In the wiring portion 13, the wires 10 are disposed to be arranged in the widthwise direction.

As shown in FIG. 2, the suspension board with circuit 1 includes the metal supporting board 2, the insulating base layer 3 as an insulating layer formed on the metal supporting board 2, the conductive pattern 4 formed on the insulating base layer 3, and the insulating cover layer 5 formed on the insulating base layer 3 so as to cover the conductive pattern 4.

The metal supporting board 2 is formed of a metal foil or a metal thin plate. As shown in FIG. 1, the metal supporting board 2 is also formed in the magnetic-head mounting region 11, the wiring portion 13, and the external region 12 correspondingly to the respective outer shapes thereof. As described later in detail, the metal supporting board 2 is formed such that a thickness T1 thereof in the magnetic-head mounting region 11 is smaller than a thickness T2 thereof in the wiring portion 13 and in the external region 12.

As shown in FIG. 2, the insulating base layer 3 is formed on the surface of the portion of the metal supporting board 2 corresponding to the conductive pattern 4. The insulating base layer 3 is formed continuously over the magnetic-head mounting region 11, the wiring portion 13, and the external region 12 to expose the peripheral end portion of the metal supporting board 2.

The conductive pattern 4 is formed on the surface of the insulating base layer 3. As shown in FIG. 1, the conductive pattern 4 is formed as a wired circuit pattern consisting of a plurality of (e.g., six) wires 10a, 10b, 10c, 10d, 10e, and 10f provided in parallel along the longitudinal direction in a longitudinally middle portion of the suspension board with circuit 1, specifically in the wiring portion 13, the head-side terminal portions 6 in the magnetic-head mounting region 11, and the external terminal portions 7 in the external region 12.

In the conductive pattern 4 in the wiring portion 13, the wires 10a, 10b, 10c, 10d, 10e, and 10f are arranged in parallel in this order from one widthwise side toward the other widthwise side.

The head-side terminal portions 6 are formed as quadrilateral lands in the magnetic-head mounting region 11, and disposed to be arranged along the widthwise direction. The head-side terminal portions 6 are connected to the respective front ends of the wires 10.

The external terminal portions 7 are formed as quadrilateral lands in the external region 12, and disposed to be arranged along the longitudinal direction. The external terminal portions 7 are connected to the respective rear ends of the wires 10.

The width of each of the wires 10 is in a range of, e.g., 10 to 150 μm, or preferably 20 to 100 μm. The spacing between the individual wires 10 is in a range of, e.g., 10 to 200 μm, or preferably 20 to 150 μm.

As shown in FIG. 2, the insulating cover layer 5 is formed on the surface of the insulating base layer 3 so as to cover the wires 10, and expose the terminal portions 9. The insulating cover layer 5 is formed continuously over the magnetic-head mounting region 11, the wiring portion 13, and the external region 12 so as to correspond to the wires 10.

On the surface of each of the terminal portions 9 of the suspension board with circuit 1, a metal plating layer 8 is formed.

Next, the front end portion of the suspension board with circuit 1 is described in detail.

As shown in FIGS. 1 and 2, at the front end portion of the suspension board with circuit 1, the magnetic-head mounting region 11 is formed as the gimbal portion 21 which provides the magnetic head 23 with followability with respect to a magnetic disk.

The gimbal portion 21 is disposed at the front end portion of the suspension board with circuit 1, and formed continuously to extend frontwardly from the front end of the wiring portion 13, and formed in a generally rectangular plan view shape protruding on both widthwise outsides of the wiring portion 13. In the gimbal portion 21, a slit 15 is formed as a generally U-shaped opening which is open toward the front side (one longitudinal side) when viewed in plan view. The slit 15 extends through the metal supporting board 2 in a thickness direction.

The gimbal portion 21 integrally includes a rear portion 19 located rearward of the slit 15, a tongue portion 16 widthwise interposed in the slit 15, an outrigger portion 17 located on both widthwise outsides of the slit 15, and a front portion 18 located frontward of the tongue portion 16.

The rear portion 19 is defined as a region in a generally rectangular plan view shape extending from the front end of the wiring portion 13 to the slit 15 in the longitudinal direction.

The tongue portion 16 is partitioned by the slit 15 to be formed in a generally rectangular plan view shape. The tongue portion 16 includes a mounting portion 20 and a terminal formation portion 22.

The mounting portion 20 is a region where the slider 24 with the magnetic head 23 mounted thereon, which is indicated by the imaginary line in FIG. 2, is mounted. The mounting portion 20 is located in the rear-side part of the tongue portion 16, and defined in a generally rectangular plan view shape extending in the widthwise direction.

The terminal formation portion 22 is a region where the head-side terminal portions 6 are formed, and located frontward of the mounting portion 20 in opposing relation thereto.

The outrigger portion 17 is formed so as to protrude on both widthwise outsides from the rear portion 19 and from the front portion 18. Specifically, the outrigger portion 17 is defined in a generally rectangular plan view shape extending along the longitudinal direction. The outrigger portion 17 is formed so as to connect the widthwise outer end portion of the rear portion 19 and the widthwise outer end portion of the front portion 18.

The front portion 18 is defined as a region in a generally rectangular plan view shape extending from the front end of the tongue portion 16 to the front end edge of the gimbal portion 21. The front portion 18 is defined to span between the widthwise inner end portions of the front end portion of the outrigger portion 17.

In the gimbal portion 21, the wires 10 are routed such that the three wires 10 (10a, 10b, and 10c) on one widthwise side, and the three wires 10 (10d, 10e, and 10f) on the other widthwise side extend from the front end of the wiring portion 13 through the rear portion 19, the outrigger portion 17, and the front portion 18, and reach the terminal formation portion 22 so as to be connected to the head-side terminal portions 6. Specifically, each of the wires 10 is routed so as to be bent widthwise outwardly at the rear portion 19, also bent toward one longitudinal side at the rear end portion of the outrigger portion 17, further bent widthwise inwardly at the front end portion of the outrigger portion 17, and then bent toward the other longitudinal side at the front portion 18.

In the suspension board with circuit 1, as shown in FIG. 2, the metal supporting board 2 is formed such that the thickness T1 thereof in the gimbal portion 21 and in the front end portion 25 of the wiring portion 13 is smaller than the thickness T2 thereof in the other region of the metal supporting board 2, i.e., in the longitudinally middle portion (hereinafter simply referred to as the middle portion) and rear end portion of the wiring portion 13 and in the external region 12.

Specifically, as shown in the shaded portion of FIG. 1 and in FIG. 2, the thickness T1 of the metal supporting board 2 in the gimbal portion 21 (including the rear portion 19, the tongue portion 16, the outrigger portion 17, and the front portion 18) and in the front end portion 25 of the wiring portion 13 is in a range of, e.g., not less than 10 μm and less than 15 μm, or preferably not less than 11 μm and less than 14 μm. When the thickness T1 of the metal supporting board 2 in the gimbal portion 21 is within the range shown above, it is possible to reliably impart excellent followability to the magnetic head 23.

On the other hand, the thickness T2 of the metal supporting board 2 in the middle portion and rear end portion of the wiring portion 13 and in the external region 12 is in a range of, e.g., not less than 15 μm and not more than 25 μm, or preferably not less than 18 μm and not more than 20 μm. When the thickness T2 of the metal supporting board 2 in the wiring portion 13 (in the middle portion and rear end portion thereof) and in the external region 12 is within the range shown above, it is possible to reliably ensure high rigidity to the suspension board with circuit 1.

More specially, the metal supporting board 2 is formed such that the thickness T1 thereof in the gimbal portion 21 and in the front end portion 25 of the wiring portion 13 is smaller than the thickness T2 thereof in the middle portion and rear end portion of the wiring portion 13 and in the external region 12 by, e.g., 1 to 15 μm, or preferably 4 to 12 μm.

When the thicknesses T1 and T2 of the metal supporting board 2 mentioned above satisfy the relations shown above, it is possible to reliably impart excellent followability to the magnetic head 23, and also reliably ensure high rigidity to the suspension board with circuit 1.

Next, a producing method of the suspension board with circuit 1 is described with reference to FIGS. 3 to 5.

In the method, as shown in FIG. 3(a), the metal supporting board 2 is prepared first.

Examples of a metal used to form the metal supporting board 2 include stainless steel and a 42-alloy. Preferably, stainless steel is used. The thickness T2 of the metal supporting board 2 is the same as the foregoing thickness T2 of the metal supporting board 2 in the external region 12.

Next, as shown in FIG. 3(b), the insulating base layer 3 is formed on the metal supporting board 2.

Examples of an insulating material used to form the insulating base layer 3 include synthetic resins such as polyimide, polyether nitrile, polyether sulfone, polyethylene terephthalate, polyethylene naphthalate, and polyvinyl chloride. Preferably, a photosensitive synthetic resin is used, or more preferably, photosensitive polyimide is used.

To form the insulating base layer 3, e.g., a photosensitive synthetic resin is coated on the surface of the metal supporting board 2, dried, exposed to light in a pattern in which the insulating base layer 3 is formed, developed, and then cured as necessary.

Otherwise, the insulating base layer 3 can be formed in the foregoing pattern by, e.g., uniformly coating a solution of any of the synthetic resins mentioned above on the surface of the metal supporting board 2, drying the solution, curing it as necessary by heating, and then etching it.

Otherwise, the insulating base layer 3 can also be formed by, e.g., preliminarily forming the synthetic resin into a film in the foregoing pattern, and sticking the film onto the surface of the metal supporting board 2 via a known adhesive layer.

The thickness of the insulating base layer 3 thus formed is in a range of, e.g., 1 to 20 μm, or preferably 8 to 15 μm.

Next, as shown in FIG. 3(c), the conductive pattern 4 is formed on the insulating base layer 3.

Examples of a conductive material used to form the conductive pattern 4 include copper, nickel, gold, tin, a solder, and an alloy thereof. Preferably, copper is used.

To form the conductive pattern 4, a known patterning method such as, e.g., an additive method or a subtractive method is used. Preferably, the additive method is used.

Specifically, in the additive method, a conductive seed film is formed first on the surface of the metal supporting board 2 including the insulating base layer 3 by a sputtering method or the like. Then, a plating resist is formed in a pattern reverse to the conductive pattern 4 on the surface of the conductive seed film. Thereafter, on the surface of the conductive seed film on the insulating base layer 3 exposed from the plating resist, the conductive pattern 4 is formed by electrolytic plating. Thereafter, the plating resist and the portion of the conductive seed film where the plating resist is laminated are removed.

The thickness of the conductive pattern 4 thus formed is in a range of, e.g., 3 to 50 μm, or preferably 5 to 25 μm.

Next, as shown in FIG. 3(d), the insulating cover layer 5 is formed on the insulating base layer 3. As an insulating material for forming the insulating cover layer 5, the same insulating material as used to form the insulating base layer 3 can be listed.

To form the insulating cover layer 5, e.g., a photosensitive synthetic resin is coated on the surface of the insulating base layer 3 including the conductive pattern 4, dried, exposed to light in the foregoing pattern, developed, and then cured as necessary.

Otherwise, the insulating cover layer 5 can be formed in the foregoing pattern by, e.g., uniformly coating a solution of the synthetic resin mentioned above on the surface of the insulating base layer 3 including the conductive pattern 4, drying the solution, curing it as necessary by heating, and then etching it.

Otherwise, the insulating cover layer 5 can also be formed by, e.g., preliminarily forming the synthetic resin into a film in the foregoing pattern, and sticking the film onto the surface of the insulating base layer 3 including the conductive pattern 4 via a known adhesive layer.

The thickness of the insulating cover layer 5 thus formed is in a range of, e.g., 2 to 25 μm, or preferably 3 to 10 μm.

Next, as shown in FIG. 4(e), a metal plating layer 8 is formed on the surface of each of the terminal portions exposed from the insulating cover layer 5.

Examples of a metal material used to form the metal plating layer 8 include gold and nickel.

To form the metal plating layer 8, e.g., a plating resist not shown is formed so as to cover the metal supporting board 2, and then electrolytic plating or electroless plating, or preferably electrolytic gold plating or electroless gold plating, is performed. Thereafter, the plating resist is removed.

The thickness of the metal plating layer 8 thus formed is in a range of, e.g., 0.2 to 3 μm, or preferably 0.5 to 2 μm.

Next, as shown in FIG. 4(f), the metal supporting board 2 corresponding to the gimbal portion 21 and to the front end portion 25 of the wiring portion 13 is thinned.

Specifically, the lower portion of the metal supporting board 2 corresponding to the gimbal portion 21 and to the front end portion 25 of the wiring portion 13 is removed.

As a method for removing the lower portion of the metal supporting board 2, etching, e.g., is used.

To etch the lower portion of the metal supporting board 2, an etching resist (etching mask) 26 is laminated on the surface (including the upper surfaces of the insulating cover layer 5, the conductive pattern 4, the insulating base layer 3, and the metal supporting board 2) of the suspension board with circuit 1 and on the back surface (lower surface) of the metal supporting board 2 corresponding to the middle portion and rear end portion of the wiring portion 13 and to the external region 12, as shown in FIG. 5(a).

To laminate the etching resist 26, a photosensitive dry film resist is laminated on each of the upper surface and back surface of the suspension board with circuit 1. Then, the dry film resist is exposed to light via a photomask, and developed to form the etching resist in the foregoing pattern.

Next, as shown in FIG. 5(b), the lower portion of the metal supporting board 2 exposed from the etching resist 26 is removed by etching.

As an etchant used for the etching, a known etchant such as, e.g., an aqueous ferric chloride solution is used. As an etching condition, a known half etching condition is selected appropriately depending on an application and a purpose.

Thereafter, the etching resist 26 is removed by, e.g., stripping, etching, or the like.

In this manner, the thickness T1 of the metal supporting board 2 corresponding to the gimbal portion 21 and to the front end portion 25 of the wiring portion 13 can be reduced to a value smaller than the thickness T2 of the metal supporting board 2 corresponding to the middle portion and rear end portion of the wiring portion 13 and to the external region 12.

Next, as shown in FIG. 4(g), the metal supporting board 2 is trimmed by, e.g., etching, punching, laser processing, or the like, while the slit 15 is formed, whereby the suspension board with circuit 1 is obtained. As a result, the gimbal portion 21, the wiring portion 13, and the external region 12 are formed in the suspension board with circuit 1.

In the suspension board with circuit 1, the metal supporting board 2 is formed such that the thickness T1 thereof in the gimbal portion 21 and in the front end portion 25 is smaller than the thickness T2 thereof in the middle portion and rear end portion of the wiring portion 13 and in the external region 12. This can allow the metal supporting board 2 in the gimbal portion 21 to have excellent flexibility and followability. When the slider 24 is mounted on the mounting portion 20 of the gimbal portion 21, the magnetic head 23 can be allowed to flexibly follow depressions and projections on the surface of the magnetic disk (not shown). Therefore, it is possible to improve the recording density of the hard disk drive.

On the other hand, the metal supporting board 2 is formed such that the thickness T2 thereof in the middle portion and rear end portion of the wiring portion 13 and in the external region 12 is larger than the thickness T1 thereof in the gimbal portion 21. This can ensure high rigidity to the metal supporting board 2 in the middle portion and rear end portion of the wiring portion 13 and in the external region 12.

As a result, when the suspension board with circuit 1 is mounted in the hard disk drive, it is possible to provide the magnetic head 23 with excellent followability with respect to the magnetic disk, while preventing the production of a defective product due to a warp or a crinkle during the production of the suspension board with circuit 1. In addition, when the suspension board with circuit 1 is incorporated into the hard disk drive, it can be incorporated with an excellent handling property.

In the description given above, the thickness T1 of the metal supporting board 2 in each of the gimbal portion 21 and the front end portion 25 of the wiring portion 13 is set smaller than the thickness T2 of the metal supporting board 2 in the middle portion and rear end portion of the wiring portion 13 and in the external region 12. However, only the thickness T1 of the metal supporting board 2 in the gimbal portion 21 can also be set smaller, though not shown.

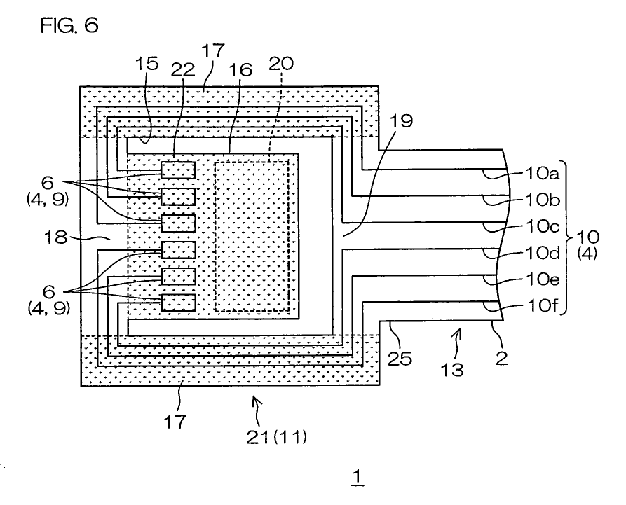

As shown in the shaded portion of FIG. 6, only the thickness T1 of the metal supporting board 2 in the tongue portion 16 and outrigger portion 17 of the gimbal portion 21 can be set smaller than the thickness T2 of the metal supporting board 2 in the wiring portion 13 and in the external region 12. Alternatively, the thickness T1 of the metal supporting board 2 in either the tongue portion 16 or the outrigger portion 17 can also be set smaller.

### EXAMPLE

Hereinbelow, the present invention is described more specifically by showing the example. However, the present invention is by no means limited to the example.

### EXAMPLE 1

A metal supporting board made of stainless steel and having a thickness (T) of 25 μm was prepared first (see FIG. 3(a)). Then, a varnish of a photosensitive polyamic acid resin was coated on the surface of the metal supporting board, dried, exposed to light, developed, and then cured by heating to form an insulating base layer made of polyimide and having a thickness of 10 μm in the foregoing pattern (see FIG. 3(b)).

Then, on the surface of the insulating base layer including the metal supporting board, a chromium thin film having a thickness of 0.03 μm and a copper thin film having a thickness of 0.07 μm were successively formed as conductive thin films by chromium sputtering and copper sputtering. Subsequently, a plating resist in a pattern reverse to a conductive pattern was formed on the surface of the conductive thin film. Thereafter, the conductive pattern having a thickness of 15 μm was formed by electrolytic copper plating on the surface of the conductive thin film exposed from the plating resist. Then, the plating resist and the portions of the conductive thin films where the plating resist was formed were removed by chemical etching (see FIG. 3(c)).

Then, a varnish of a photosensitive polyamic acid resin was coated on the surface of the insulating base layer including the conductive pattern, dried, exposed to light, developed, and then further cured by heating to form an insulating cover layer made of polyimide and having a thickness of 5 μm in a pattern which covered wires, and exposed terminal portions (see FIG. 3(d)). Subsequently, a metal plating layer made of gold and having a thickness of 0.5 μm was formed by electrolytic gold plating on the surface of each of terminals (see FIG. 4(e)).

Then, the metal supporting board in a gimbal portion and in the front end portion of a wiring portion was etched (see FIG. 4(f)).

That is, a photosensitive dry film resist was laminated first on each of the upper surface and back surface of a suspension board with circuit, exposed to light via a photomask, and developed to form an etching resist in a pattern which exposed the gimbal portion and the front end portion of the wiring portion (see FIG. 5(a)).

Then, a lower portion of the metal supporting board exposed from the etching resist was removed by etching using an aqueous ferric chloride solution as an etchant (see FIG. 5(b)).

Thereafter, the etching resist was removed by stripping using an aqueous sodium hydroxide solution as a stripping agent.

As a result, the thickness (T1) of the metal supporting board in the gimbal portion and in the front end portion of the wiring portion was formed smaller by 12 μm than the thickness (T2) of the metal supporting board in an external region, which was 25 μm. Specifically, the thickness (T1) of the metal supporting board was 13 μm.

Then, the metal supporting board was trimmed by chemical etching, while a slit was formed, whereby the suspension board with circuit was obtained (see FIGS. 1 and 4(g)).

While the illustrative embodiments of the present invention are provided in the above description, such is for illustrative purpose only and it is not to be construed limitative. Modification and variation of the present invention that will be obvious to those skilled in the art is to be covered by the following claims.

What is claimed is:

1. A suspension board with circuit comprising:
a metal supporting board extending in a longitudinal direction;
an insulating layer formed on the metal supporting board; and
a conductive pattern formed on the insulating layer, wherein
a magnetic-head mounting region where a slider with a magnetic head mounted thereon is mounted is located in one end portion in the longitudinal direction, and
a thickness of the metal supporting board in at least a part of the magnetic-head mounting region is smaller than that in a region other than the magnetic-head mounting region.

2. The suspension board with circuit according to claim 1, wherein
an opening having a generally U-shaped shape which is open toward one side in the longitudinal direction is formed in the magnetic-head mounting region, and
the magnetic-head mounting region includes:
a tongue portion interposed in the opening in a perpendicular direction perpendicular to the longitudinal direction; and
an outrigger portion located on both outsides in the perpendicular direction of the opening, wherein
the thickness of the metal supporting board in at least the tongue portion and/or the outrigger portion is smaller than that in the region other than the magnetic-head mounting region.

3. The suspension board with circuit according to claim 1, wherein
the thickness of the metal supporting board in at least the part of the magnetic-head mounting region is not less than 10 μm and is less than 15 μm, and
the thickness of the metal supporting board in the region other than the magnetic-head mounting region is not less than 15 μm and not more than 25 μm.

4. The suspension board with circuit according to claim 1, wherein the thickness of the metal supporting board in at least the part of the magnetic-head mounting region is smaller by 1 to 15 μm than that in the region other than the magnetic-head mounting region.
